(19) United States
(12) Patent Application Publication
(10) Pub. No.: US 2006/0285556 A1
(43) Pub. Date: Dec. 21, 2006

(54) Method for determining the quality of a data transmission

(75) Inventor: Andreas Schneck, Au am Rhein (DE)

Correspondence Address: DAVIDSON, DAVIDSON & KAPPEL, LLC, 485 SEVENTH AVENUE, 14TH FLOOR, NEW YORK, NY, 10018, US

(73) Assignee: WEB.DE AG, Karlsruhe (DE)

(21) Appl. No.: 10/555,563

(22) PCT Filed: Apr. 29, 2004
(86) PCT No.: PCT/EP04/04568

§ 371 Date: Nov. 4, 2005

(30) Foreign Application Priority Data
May 5, 2003 (DE) 103200916

(51) Int. Cl. H04J 1/00

(52) U.S. Cl. 370/490

(57) ABSTRACT

A method for data transmission includes determining whether a data transmission limit value is infringed during a transmitting, over a network, of first data for a first receiver. In response to an infringement of the data transmission limit value during the transmitting: interrupting the transmitting of the first data; replacing the transmitting of the first data by a transmitting of second data for the receiver: and discarding the first data.

### FIELD OF THE INVENTION

The present invention relates generally to the transmission of data between computer systems over a network, such as for example between the server of an Internet provider and a computer system of a user of the Internet provider's services over the Internet. In particular the present invention relates to a method for ascertaining the quality of such data transmissions.

### BACKGROUND OF THE INVENTION

When transmitting data over a network, such as for example the Internet, a key variable for transmission quality is the speed with which data are transmitted from the sending computer system to the receiving computer system. Data transmission speeds or rates are affected by, inter alia, the minimum bandwidth of the transmission route between the two computer systems involved and by the computer systems themselves, in particular by the receiving computer system.

In view of the increasing quantities of data which are for example transmitted over the Internet to computer systems of internet users, this variable is becoming increasingly more important. In particular from the point of view of an Internet user it is desirable that no delays perceptible to the Internet user occur in the transmission of data from the Internet. In order to prevent such undesired effects for the user it is at present customary, for example in the Internet sector, to limit graphics to be shown on web pages, especially advertising media, in respect of the data needed for them. For example, advertising media in the form of banners are currently limited to data quantities of up to 20 KB. This in turn has the disadvantage that, continuing with this example, it is not possible for advertisers to use high-quality, high-definition, animated graphics, video sequences and music of high quality, which are communicated over the Internet.

One possibility of optimizing data transmissions over a network taking account of the technical properties of an available transmission route is to communicate corresponding information, before a data transmission, from a computer system to which data are to be transmitted to the computer system sending the data. The disadvantage here is that, if such information is not sent, data transmissions cannot be optimized accordingly. Further, it is usually necessary for a user of the computer system proposed for reception to enter this information into same and transmit it to the sending computer system under user control.

In the field of the Internet it is also known to adapt data transmissions by using the IP address of a computer system proposed for reception to check which technical properties will be present with regard to data transmissions on the part of the computer system, in order to enable identification of “fast users”. Generally “fast users” IP addresses supplied by Internet providers (e.g. Internet users with a DSL modem) are used, but the supply and use of these incur a cost.

This procedure, also called IP targeting, also has the disadvantage that the corresponding technical properties of the computer system proposed for reception can often not be inferred using an IP address. IP addresses are in fact not necessarily allocated to a specific Internet user, but an IP address can be allocated successively to various users. If, for example, many Internet user access the Internet by means of a DSL modem, it is customary, due to the limited number of available IP addresses, to allocate to these users IP addresses which are actually provided for Internet users with slow modems. In such a case an Internet user with a fast modem cannot be recognized as such.

A further disadvantage is that the transmission properties of an available transmission route can often not be inferred using an IP address. Thus, for example, an IP address does not indicate which bandwidth is available for data transmission on the part of the network and how a computer system proposed for reception is utilized. In the case of the above-named example of advertising banners this can, for example, lead to an Internet user [who] has been identified as a “fast user” on the basis of his IP address receiving a large advertising banner, i.e. a banner based on a large quantity of data, although the bandwidth available is not sufficient for this; consequently the build-up of the advertising banner on this Internet user's monitor will be delayed.

A system is proposed in U.S. Pat. No. 6,243,761 B1 in which a decision as to which files are to be transmitted is made after measuring the transmission rate.

In US 2001/0010059 A1 a test file is transmitted in order to measure the transmission rate. Thereafter it is decided which file is to be transmitted.

According to US 2002/011658 A1 the bandwidth is determined which is available for data transmissions over the Internet between a server and a computer system of an Internet user to whom the data are to be transmitted.

Here, in a first step, a first quantity of data is transmitted to the computer system and the period of time necessary to completely send this quantity of data from the server to the computer system is measured. The bandwidth is then determined from the period of time necessary to transmit the quantity of data. If the thus-determined bandwidth is sufficient for example to show a high-resolution graphic in a way acceptable to the Internet user, i.e. quickly enough to display it on the computer system, a first software application which is suitable for this representation is selected and executed on the computer system.

If the thus-determined bandwidth is not sufficient, in a second step a second quantity of data is transmitted from the server over the Internet to the computer system and the bandwidth determined anew. If the bandwidth determined in the second step is sufficient for example to reproduce a lower-resolution graphic on the computer system, a second software application suitable for this is chosen and executed on the computer system.

If the bandwidth ascertained in the second step is not sufficient, the bandwidth can be determined anew using a third quantity of data, in order to either execute a third software application suitable for this or carry out another bandwidth measurement.

If a software application has been selected on the computer system according to the last-determined bandwidth, the data to be reproduced with the selected software application are transmitted from the server to the computer system.

This procedure has several disadvantages. An essential aspect of this procedure is to ascertain the bandwidth provided by the network. In order to achieve this, further factors which can influence the period of time needed to transmit the quantities of data used to determine the bandwidth are taken into account so that the period of time used to determine the bandwidth essentially corresponds to the actual duration of transmission over the Internet, based on the bandwidth available there.

This can lead, on the basis of a last-determined bandwidth, to a software application being chosen and executed on the computer system, and data transmitted to the computer system which are suitable in the light of the last-determined bandwidth but unsuitable for other reasons, because for example they lead to a duration that is unsatisfactory for the Internet users when showing the transmitted data. This can be the case for example if, on the one hand, a high bandwidth is available for data transmission, on the other hand the computer system cannot process the received quantities of data quickly enough; this can be caused in particular by a method used with the computer system for the temporary storage of received data (“caches”).

Furthermore it is necessary in this procedure, on the one hand to determine the bandwidth and, on the other hand, then transmit the data chosen according to the bandwidth.

According to US 2001/0044835 A1 the bandwidth in the case of a data transmission which is available for a data transmission between a server and a computer system of an Internet user is determined. The contents to be transmitted or quantities of data to be transmitted to the computer system of the Internet user, corresponding to them, are chosen according to the determined bandwidth. To determine the bandwidth, a predetermined quantity of data is transmitted from the server to the computer system and the duration of transmission necessary for this measured. The predetermined quantity of data used comprises data necessary exclusively to measure the bandwidth; data reproducing contents to be transmitted are not transmitted.

According to WO3/007171 A1, comparable with the last-named method, the bandwidth is ascertained which is available for data transmissions between a server and a computer system of an Internet user. It is proposed in particular to transmit test data from the server to the computer system over a signal path whose bandwidth is to be determined. Thereafter, in a step separated from the bandwidth measurement, contents proposed for the Internet user are transmitted which are chosen according to the determined bandwidth.

There is a disadvantage in the last-named approaches in that changes of the available bandwidth can no longer be taken into account after the bandwidth has been determined. This can, for example, lead to data proposed according to a specific bandwidth for transmission being transmitted but a bandwidth being available upon their transmission which differs from the determined bandwidth so that the originally suitable data become unsuitable data.

There is also a disadvantage in the above-named approaches in that they are executed merely according to characteristics, i.e. in particular the bandwidth, of a transmission route between a server and a computer system of an Internet user. Other factors which can influence the quality of such data transmissions are not taken into account.

### OBJECT OF THE INVENTION

The object of the present invention is to provide solutions to optimize data transmissions over a network, in particular over the Internet, with regard to the data-transmission quality available. In particular the present invention is to make it possible to execute these in the case of data transmissions over a network such that they are executed according to an actually present data-transmission quality.

### BRIEF DESCRIPTION OF THE INVENTION

To achieve this object the present method provides a method in which a transmission of first data for a receiver is interrupted and replaced by a transmission of second data for the receiver and the first data are discarded if a data transmission limit value is infringed during the transmission of the first data.

By the first and second data for the receiver are meant useful data, i.e. data which are proposed for actual utilization on the part of the receiver. The receiver can be a computer system to which the first and optionally the second data are transmitted, a user of a computer system receiving the data and also a computer system receiving the data and a user of same in combination.

The first and second data are in particular one or more files or a data packet for actual use on the part of the receiver, i.e. useful data. It is particularly preferably a graphic file such as for example an advertising banner.

To illustrate the importance of the first and second data for the receiver, reference is made to known methods which, as described above, for example transmit a predetermined quantity of data or test data over a network in order to determine a bandwidth available during a data transmission. The data used with these known methods are not only proposed for a receiver as such, but serve another purpose, for example ascertaining a bandwidth; these data do not comprise data desired or required for the operation of a receiving computer system (e.g. software applications to be executed on the computer system, information to be reproduced, graphics, text, etc.) and data can be used by a user of a receiving computer system.

Contrary to this, the first and second data for the receiver comprise data which can be used by a receiving computer system and/or its user. Apart from data of the first and second data which for example are required for the transmission over the network or by a receiving computer system to process the first and second data, the first and second data for the receiver can be seen as data which comprise “exclusively” data which can actually be used by a receiving computer system and/or its user; accordingly the first and second data for the receiver can be seen as data which for example consist of a software application or text and/or image information to be executed on a receiving computer system which are made available to a user on a monitor of a receiving computer system.

By a data transmission limit value is meant in the following for example a variable which characterizes the quality of a transmission of data over the network. The data transmission limit value can for example be a threshold value, the infringement of which indicates that the quality of the data transmission over the network is not sufficient for the transmission of the first data. Instead of a threshold value, the data transmission limit value can also indicate a range, the infringement of which indicates an insufficient data-transmission quality in respect of the first data.

If the data transmission limit value indicates a threshold value, an infringement of the data transmission limit value is to be taken to mean that the threshold value has not been reached and that it has been exceeded. If the data transmission limit value indicates a range, an infringement of the data transmission limit value occurs if the transmission of the first data is executed with a quality which is inside of the range or outside the range.

The method according to the invention has several advantages. Data transmissions over a network are executed not only according to the transmission route used for data transmission. Rather, the present invention allows data transmissions over a network to be executed taking account of the available data-transmission quality. Overall, with the method according to the invention it is no longer necessary to use data specifically proposed for ascertaining a data-transmission quality, for example in the form of test data. Rather, with the method according to the invention, the data, namely the first data which serve for utilization on the part of the receiver, are also used to ascertain the data-transmission quality.

Another advantage of the present invention is that that ascertaining of a data-transmission quality does not take place at a separate time from the transmission of data which are proposed for a receiver. Rather, with the method according to the invention, the ascertaining of data-transmission quality and the transmission of data proposed for a receiver are carried out at the same time. It is possible with the method according to the invention, during a transmission of data proposed for a receiver, to obtain a “snapshot” of the current data-transmission quality.

In a preferred version the transmission of the data is continued if the data transmission limit value is not infringed. This has the advantage that the period of time needed to transmit the first data completely is not delayed by a previously executed transmission of data for ascertaining a data-transmission quality.

In order to more finely adapt data transmissions to the present data-transmission quality it is proposed to predefine at least two data transmission limit values. The indications made above with regard to the data transmission limit value apply accordingly to these at least two data transmission limit values. It is proposed that at least two second data are predefined. During transmission of the first data it is then checked which of the at least two data transmission limit values is infringed. Depending on which of the at least two data transmission limit values is infringed, the second data are selected from the at least two second data which are suitable in respect of the infringed data transmission limit value.

This procedure makes it possible, by checking the data-transmission quality, namely upon the initial transmission of the first data, to more precisely ascertain the existing data-transmission quality. If, for example, a high number of closely-spaced data transmission limit values is chosen, the data-transmission quality can be determined as precisely as desired. If for example only first first or second data are completely transmitted, it is sufficient in principle to define merely one transmission value. If information about the existing data-transmission quality are also to be used or if more precise information about the existing data-transmission quality is desired it is advantageous, also when using merely first and second data, to predefine more than one data transmission limit value.

It is possible, for example, to predetermine a first and a second data transmission limit value and allocate first second data or second second data to these. If it is noted during transmission of the first data that the first data transmission limit value is infringed, the first second data are transmitted after the transmission of the first data has been interrupted. If the second data transmission limit value is infringed, the second second data are transmitted after the transmission of the first data has been interrupted.

In one version, there can be an infringement of the data transmission value if, during the transmission of the first data, within a predefined period of time, a quantity of data is transmitted which is smaller than a predefined quantity of data.

In another version, there can be an infringement of the data transmission limit values if a period of time needed to transmit a predefined quantity of data comprised by the first data is not reached.

The infringement of the data transmission limit value can indicate for example that the available data-transmission quality is not sufficient to transmit the first data in the desired form, i.e. the data-transmission quality is not sufficient to transmit the first data quickly enough.

As, upon the infringement of the data transmission limit value it is not the first data as a whole, but merely a predefined quantity of data that is taken as the basis, it is also not necessary to completely transmit the first data in order to determine the data-transmission quality. Rather, the data-transmission quality can be ascertained very quickly, for example so that, if the transmission of the first data is interrupted, a receiver for the first data cannot be aware of this.

In these cases the first data as a whole preferably comprise a greater quantity than the second data.

As an alternative to the first of the two last-named versions, it is proposed that there is an infringement of the data transmission limit value if, during transmission of the first data, within a predefined period of time a quantity of data is transmitted which is greater than a predefined quantity of data.

As an alternative to this, it is proposed that there is an infringement of a data transmission limit value indicates that, during transmission of a first predefined quantity of data comprised by the first data, a predefined period of time has not been reached.

In these cases, in the second alternative the first data as a whole cover a smaller quantity of data than the second data.

Preferably the first data indicate a first banner and the second data a second banner. It is also possible that the predefined quantity of data of the first banner and the second data in combination with the predefined quantity of data indicate a second banner.

By a banner is meant in the following graphic items of information which are represented in the reproduction of a current web page on a monitor of a computer system used to access the current web page. Banners are embedded in HTML documents used for web pages and can be represented in various variables and in various ways.

Standardized banner sizes comprise so-called full-size banners measuring 468*60 pixels but the so-called half-size banner measuring 234*60 pixels has now been abandoned. However, some other sizes have proved to be particularly suitable and are preferably used, such as e.g. the so-called Big Size banner measuring 728*90 pixels.

A distinction is also drawn between animated and static banners. Animated banners can be based on data in GIF format and/or be produced by means of the software program known under the trade name Flash® and/or by using the graphic format known under the trade name Shockwave®. Colloquially, banners are often generically called Flash banners, which is why in the following this term covers not only banners produced with the Flash® software program but also comparable banners.

When the first data comprise a greater quantity of data than the second data the first banner can be larger than the second banner. The same applies when the first data comprise a smaller quantity of data than the second data. It is preferred that, if the data-transmission quality is inadequate from the point of view of the receiver, the second banner serve as a replacement for the first banner or vice versa.

Data which characterize the infringed data transmission limit value are preferably stored. A so-called cookie, which is stored on a receiving computer system, or comparable means (i.e. data and process), can be used for this for example. Storage of the data indicating the infringed data transmission limit value can alternatively or additionally take place on a computer system from which the first data are transmitted.

In a preferred version of the method according to the invention, data from a so-called server can be transmitted over the network to a so-called client in order to transmit the first data and, if at all necessary, to transmit the second data.

In particular it is provided that an adserver is used as server. By adserver is meant a computer system which controls advertisements which are to be shown using web pages. An adserver controls for example the web pages on which banners are to appear, the frequency with which advertisements are to be executed etc.

In a preferred version of the last-named versions the method according to the invention is executed with server control. In this case it is also preferred that a so-called servlet is used to execute the method according to the invention.

In another preferred version of the last-named version the method according to the invention is executed with client control, a web browser and/or a plug-in being able to be used here.

It is preferable in particular that when executing the method according to the invention the first data and optionally the second data are transmitted over a network which includes the Internet.

If the method according to the invention is carried out with server control the first data and optionally the second data can be transmitted from the server to the client. In this way it is possible, in addition for example to the bandwidth available on the transmission route between the server and the client, also to consider variables which are conditioned by technical properties and/or operating statuses of the server and can influence data-transmission quality.

The use of the client to execute the method according to the inventions has the advantage that, in addition to the bandwidth provided by the transmission route between the server and the client, variables are taken into account which are due to technical properties and/or operating statuses of the server and which can influence the data-transmission quality. It is possible for example that the bandwidth provided by the transmission route between the server and the client is sufficient to transmit the first data in desired ways. However, if the client is not able to process received portions or data quantities of the first data quickly enough, for example, the received data cannot be represented quickly enough, this leads to an infringement of the data transmission value although the data-transmission quality is adequate. As, in this case, the data-transmission quality is impaired by the client himself, this could only be established by the server at a high cost if at all; this would lead to delays in data transmissions between the server and the client.

The present invention also provides a computer-program product which includes program-code parts for executing one, more or all of the above-described versions of the method according to the invention.

The computer-program product according to the invention preferably comprises program-code parts which can be executed as JavaScript®, as Jscript® or in a form compatible therewith.

### BRIEF DESCRIPTION OF THE FIGURES

Reference is made in the following description of preferred versions to the attached figures in which are shown:

FIGS. 1 to 4 schematic representations of preferred versions of the method according to the invention.

### DESCRIPTION OF PREFERRED VERSIONS

Preferred versions are described in the following using the example of a scenario in which banners are to be transmitted from a server to a computer system.

Customarily, a banner is transmitted from a server to a computer system with control of data which for example are present in the form of an HTML file which is embedded in the data of a web page which is accessed by means of the computer system. Alternatively, it is possible that a banner is transmitted from the server to the computer system in response to an input on the part of the user of the computer system. Such events are described in the following as triggering events.

In order to avoid the problems named at the start, in the customary procedure banners are used which must not exceed a predefined variable or quantity of data, in order, during the transmission of banners and their representation by means of the computer system, to avoid undesired delays for the user. Therefore, in response to a triggering event which initiates the execution of an advertisement, the same banner is always transmitted, regardless of the computer system by which this event is triggered.

In the versions described below the triggering events are used which also lead to the transmission of banners with the customary procedure, e.g. “web page”-controlled or user-controlled prompting of banners. Therefore, to apply the present invention, apart from its use, no modifications of the customary procedures and the methods associated therewith are necessary.

However, with the present invention, in response to a triggering event which is to lead to the execution of an advertisement, the same banners are not transmitted to a requesting computer system as default. Rather, the present invention makes it possible to transmit different banners depending on the current data-transmission quality between the server and the computer system.

This has several advantages.

In order to check which banner is actually to be transmitted to the computer system, the data-transmission quality which is available during the transmission of banner data is determined.

Furthermore, delays which occur with the above-described use of test data and the like can be avoided by the present invention. If the limit value is not in fact infringed during the transmission of the data for the first banner, the transmission of the data for the first banner is continued. Accordingly in this case the first banner is transmitted with no delay.

If the limit value is infringed during transmission of the data of the first banner delays to the second banner can be avoided by a rapid interruption of the data transmission for the first banner, thus choosing the smallest possible period of time during which the data-transmission quality is determined.

Another optimization is possible if one or more of the versions described below are used, depending on what data-transmission quality between the server and the computer system is to be expected.

If it is to be assumed for example that there is a high data-transmission quality, a version can be used which in the first step effects a transmission of a large banner which is then normally transmitted wholly without time delay. Only when the assumed data-transmission quality is not available is the transmission of a small banner initiated. Accordingly this applies when a low data-transmission quality is to be assumed.

These procedures can also be combined if for example a high data-transmission quality is initially to be assumed, but it is found in during data transmissions between the server and the computer system that the data-transmission quality present is inadequate, thus leading more than once, frequently or regularly to the interruption of data transmission for first banners. In order to avoid the delays resulting from this during data transmissions for second banners, a version of the software application can then be used which in the first step prompts a small banner in each case and effects a transmission of large banners only if the data-transmission quality is sufficient for same. The same applies accordingly when a low data-transmission quality is initially to be assumed.

In order to be able to exploit these possibilities, it is advantageous if the various versions of the software applications needed for this purpose are present on the computer system in order that they can be executed depending on the available data-transmission quality.

To illustrate the versions described here, reference is made to an application of the present invention in the field of the Internet and the following assumptions made:
A computer system communicating over the Internet of a user which features a web browser and plug-in for so-called Flash® banners (see below) is used as client.
The plug-in prompts from a server (see below) an SWF® software application programmed in Flash® MX which is compatible with version 5 of Flash® and comprises software code for executing the method according to the invention.
An adserver of an Internet service provider is used to control advertisements proposed for the user that are to be shown on a monitor of the computer system in the form of banners.
Data for banners are transmitted from an image server of one or other Internet service provider to the computer system.

Because of their capacity to ascertain the data-transmission quality between the image server and the computer system, the software application can also be called a “speed sniffer”.

The software application is transmitted to the computer system by sending data, e.g. in the form of a HTML Javascript file, during the execution of the web browser on the computer system from a server to the computer system, which cause the software application to be prompted and transmitted to the computer system. This takes place for example by an inquiry from the plug-in of the computer system to the image server, which in response transmits the software application to the computer system.

In the versions described here, the software application contains the following software code:

<SCRIPT LANGUAGE=“JavaScript1.1”>
var clickurl = “http://web.de”
if (showFlashStatus( ))
{
document.writeln
(‘<embedsrc=

| “http://www.web.de/sniffer.swf? | |
|---|---|
| data_1=http://www.web.de/dsl200×300.swf | &bytes=BySec |
| & | |

data_2=http://www.web.de/isdn200×300.swf” quality=QL
type=“application/x-shockwave-flash”
width=“W”
height=“H”>

</EMBED>’);
FlashOk = true;
}
function ClickThru( ) { window.open(clickurl); }
</SCRIPT>

The following applies for variables of the software code:

| | |
|---|---|
| data_1: | Refers to a first flash file that serves to display a |
| | first banner on the monitor of the computer system. |
| data_2: | Refers to a second flash file that serves to display a |
| | second banner on the monitor of the computer system. |
| BySec: | Defines a limit value in bytes per second upon the |
| | infringement of which the transmission of the first |
| | flash file is interrupted and the second flash file is |
| | transmitted. |

In general, the method according to the invention proceeds as follows:

If an advertisement in the form of a banner that can be shown on the monitor of the computer system is to be executed for the user of the computer system, contrary to the conventional procedure, this does not take place by a transmission of a default banner from the image server to the computer system. Rather, the execution of the advertisement is controlled here by the software application so that banners are used depending on the data-transmission quality that is available during the transmission of banner-reproducing data from the image server to the computer system.

The software application ascertains, using the above software code, also called action script, the data-transmission quality between the image server and the computer system in bytes per second. Depending on the data-transmission quality, it is then determined which banners (flash files) are transmitted to a computer system so that the corresponding banner can be reproduced there as desired.

In response to an event that is to initiate the transmission of a banner, the software application is executed which in a first step effects the transmission of the first banner data_{—}1 from the image server to the computer system.

If it is established during this transmission that, within a predetermined period of time, e.g. one, two or more seconds, a quantity of data is transmitted from the image server to the computer system which is smaller (larger) than the quantity of data predefined by the limit value BySec, the software application interrupts the transmission of the first banner and effects the transmission of the second banner. The second banner is then transmitted in full to the computer system and can be reproduced on its monitor.

If it is established within the predetermined period of time that the quantity of data transmitted from the image server to the computer system is larger (smaller) that the quantity of data predefined by the limit value BySec, the transmission of the first banner is not interrupted, but executed in full; the first banner can then be reproduced on the monitor of the computer system.

Alternatively, in order to determine the data-transmission quality, it is possible to define a predetermined quantity of data and record the time required to transmit this quantity of data during the transmission of the data for the first banner.

If it is established, during the transmission of data for the first banner, that the predefined quantity of data is transmitted from the image server to the computer system within a period of time that is larger (smaller) than a period of time predefined by a time-related limit value, the software application interrupts the transmission of the first banner and effects the transmission of the second banner. The second banner is then transmitted to the computer system in full and can be reproduced on its monitor.

If, during the transmission of data for the first banner, a period of time which is smaller (larger) than the predefined period of time is required for the transmission of the predefined quantity of data, the transmission of the first banner is not interrupted, but executed in full; the first banner can then be reproduced on the monitor of the computer system.

Here, a functionality provided by Flash® is used which makes it possible to interrupt the transmission of data for banners that is known as loading. This functionality is called “Unload Movie” and allows a request to load a banner to be interrupted during processing (“on the flight”).

In tests, quantities of data that are transmitted within a predefined period of two seconds were determined for computer systems that can communicate over the Internet via a DSL modem. An average value of 195,455 bytes within two seconds was ascertained, the worst ascertained value being approx. 110,000 bytes within two seconds.

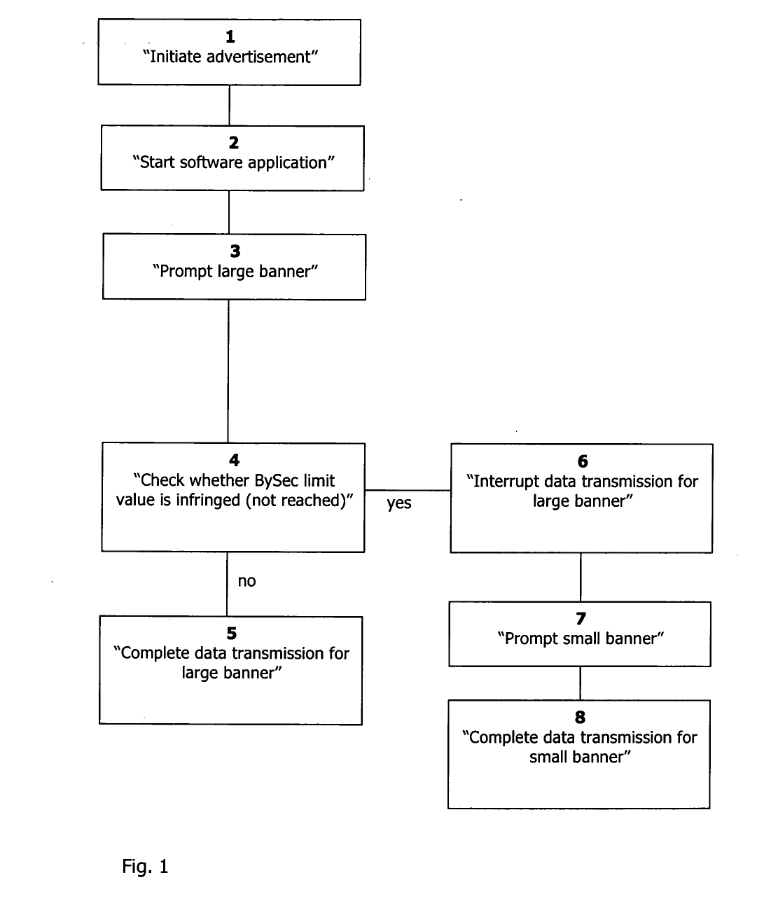

With reference to FIG. 1, the version is described in which in the first step the transmission of data for a large banner is initiated and optionally data for a small banner are transmitted.

If an event occurs that initiates the execution of an advertisement by means of a banner to be displayed on a computer system (step 1), the software application is executed (step 2). The software application then asks the image server for data of a large banner provided for the advertisement to be executed (step 3).

During the transmission of data for the large banner it is checked whether data transmitted within the predetermined period of time after start of transmission account for at least a predetermined quantity of data, i.e. a quantity of data per time above the limit value BySec is transmitted (step 4).

If this is the case, the transmission of the data for the large banner is continued (step 5). Otherwise, the transmission of data for the large banner is interrupted (step 6) and data requested from the image server of a small banner provided for the advertisement to be executed (step 7) in order to transmit same to the computer system (step 8).

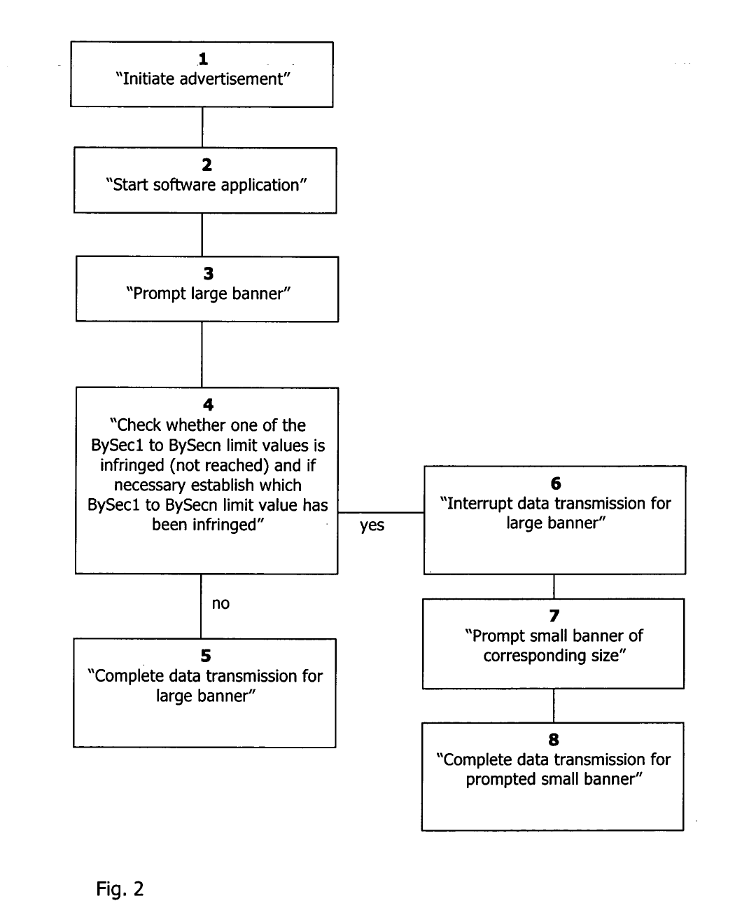

In the version shown in FIG. 2, steps 1 to 3 correspond to steps 1 to 3 of the version of FIG. 1. However, in the version of FIG. 2, the step 4 described with reference to FIG. 1 is executed in respect of at least two limit values BySec1, . . . , BySecn. Furthermore, in this version, in addition to the large banner requested in step 3, at least two small banners of different variables are used.

For simplicity's sake, it is assumed that the largest limit value BySec1 corresponds to the limit value of the version of FIG. 1 and the other limit values BySec2, . . . , BySecn have different, ever-decreasing values. It is furthermore assumed below that the at least two small banners are each allocated to one of the limit values BySec1, . . . , BySecn, the largest small banner corresponding to the small banner of the version of FIG. 1 and all further small banners having different, ever-decreasing variables.

In step 4 it is checked whether and, if so, which of the limit values BySec1, BySecn is infringed during the initial transmission of the data for the large banner.

If none of the limit values is infringed, the transmission of data for the large banner is continued (step 5). Otherwise, the transmission of data for the large banner is interrupted (step 6).

In the shown version it is checked, starting with the largest limit value BySec1 decreasing to the smallest limit value BySecn, which limit value BySec1, . . . , BySecn is infringed. Depending on the smallest infringed limit value BySec1, . . . , BySecn, data of a banner of corresponding size provided for the advertisement to be executed are requested by the image server (step 7) in order to transmit same to the computer system (step 8).

The version of FIG. 2 makes possible not only a more accurate determination of the data-transmission quality, but also a selection, optimized with reference to the existing data transmission quality, of banners to be transmitted in full.

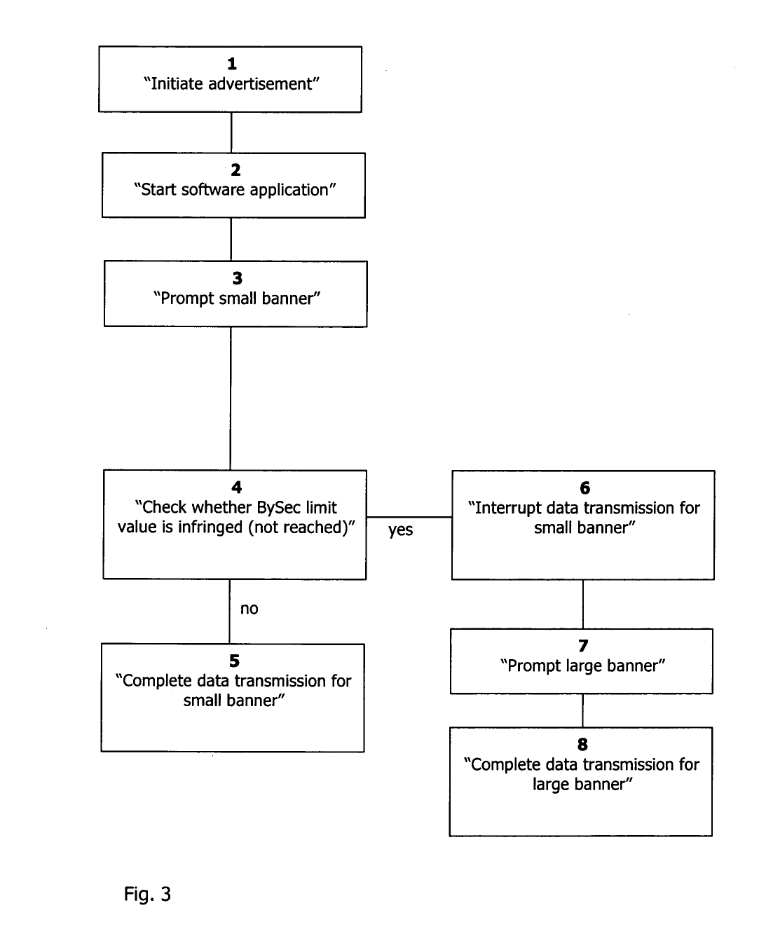

With reference to FIG. 3, the version is described in which in the first step the transmission of data for a small banner is initiated and optionally data for a large banner are transmitted.

If an event occurs that initiates the execution of an advertisement by means of a banner to be displayed on the computer system (step 1), the software application is executed (step 2). The software application then asks the image server for data of a small banner provided for the advertisement to be executed (step 3).

During the transmission of data for the small banner, it is checked whether the data transmitted within a predetermined period of time after the start of transmission account for at most a predetermined quantity of data, i.e. a quantity of data per time below the limit value BySec is transmitted (step 4).

If this is the case, the transmission of the data for the small banner is continued (step 5). Otherwise, the transmission of the data for the small banner is interrupted (step 6) and data of a large banner provided for the advertisement to be executed requested by the image server (step 7) in order to transmit same to the computer system (step 8).

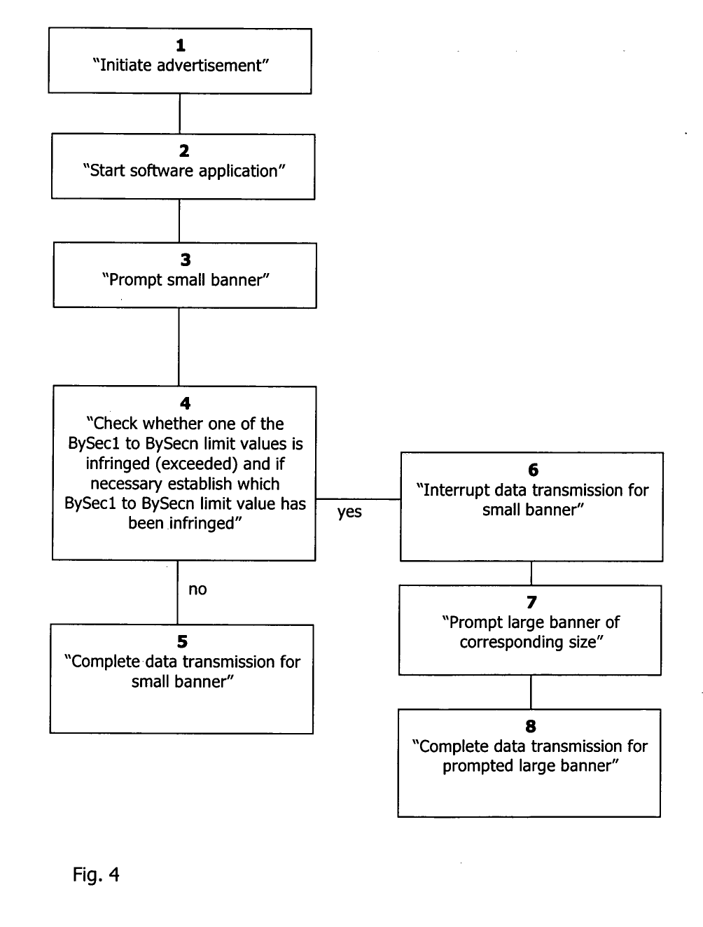

In the case of the version shown in FIG. 4, steps 1 to 3 correspond to steps 1 to 3 of the version of FIG. 3. However, in the version of FIG. 4, the step 4 described with reference to FIG. 3 is executed in respect of at least two limit values BySec1, . . . , BySecn. Furthermore, in this version, in addition to the small banner requested in step 3, at least two large banners of different variables are used.

For simplicity's sake, it is assumed that the smallest limit value BySec1 corresponds to the limit value of the version of FIG. 3 and the other limit values BySec2, . . . , BySecn have different, ever-increasing values. It is furthermore assumed below that the at least two large banners are each allocated to one of the limit values BySec1, . . . , BySecn, the smallest large banner corresponding to the large banner of the version of FIG. 3 and all further large banners having different, ever-increasing variables.

In step 4 it is checked whether and, if so, which of the limit values BySec1, . . . , BySecn is infringed during the initial transmission of the data for the small banner.

If none of the limit values is infringed, the transmission of data for the small banner is continued (step 5). Otherwise, the transmission of data for the small banner is interrupted (step 6).

In the shown version it is checked, starting with the smallest limit value BySec1 increasing to the largest limit value BySecn, which limit value BySec1, . . . , BySecn is infringed. Depending on the largest infringed limit value BySec1, . . . , BySecn, data of a banner of corresponding variable provided for the advertisement to be executed are requested by the image server (step 7) in order to transmit same to the computer system (step 8)

The version of FIG. 4 makes possible not only a more accurate determination of the data-transmission quality, but also a selection, optimized with reference to the existing data transmission quality, of banners to be transmitted in full.

In all versions, it is possible after an interruption of a transmission of data for a first banner to discard the data transmitted up to then and to transmit data that are required for the second banner as a whole. Alternatively, it is possible not to discard the data already transmitted until the interruption, but to use it for the reproduction of the second banner. The second banner is to be designed such that it can be constructed or reproduced from the data for the second banner combined with data for the first banner; in particular a first quantity of data of the data for the first banner can be used that are to be transmitted first during transmission of the data for the first banner.

When establishing which and how many data of the data for the first banner are to be used in the second banner, an expected data-transmission quality can be used as a basis in order to ensure that, after an interruption of a transmission of data for the first banner, the data required for the second banner have been transmitted. This is advantageous in particular if the version is used in which, to determine the data-transmission quality, the quantity of data transmitted during a predefined period of time is ascertained. But it is more advantageous here to use the version in which, to determine the data-transmission quality, the period of time for a transmission of a predefined quantity of data is ascertained. This in fact ensures that, during the transmission of data for the first banner, irrespective of an interruption, a predefined quantity of data is always transmitted which can then optionally be used for the second banner; it is thus avoided that, because of an interruption of the transmission of data for the first banner, data are not transmitted that are required for the second banner.

In order to be able to revert to a data-transmission quality ascertained at an earlier time, it is possible to save corresponding data. This can take place e.g. by means of a cookie to be stored on the computer system. This can be accessed in order to adapt subsequent data transmissions from and to the computer system accordingly. This has the advantage that, even in the case of data transmissions in which the present invention is not used, an optimization in respect of the data-transmission quality can be carried out. Furthermore, data indicating an ascertained data-transmission quality can be used in order to infer an expected data-transmission quality and, as indicated above, to choose a corresponding version of the software application.

With the versions described above, it is provided to use the method according to the invention for every advertisement to be executed. This is necessary on the one hand to adapt data transmissions to the existing data-transmission quality and on the other hand has the advantage of simultaneously ascertaining the data-transmission quality available during data transmissions. By way of variation from this it is possible to execute the method according to the invention at specific times and/or at specific intervals and otherwise to adapt data transmissions to the data-transmission quality on the basis of data that indicate a previously ascertained data-transmission quality. Such data can be stored for example in the form of a cookie that makes it possible to ascertain whether, and if so, what data-transmission quality has been ascertained and to determine whether, when and how often the method according to the invention is to be applied.

The storage of data that indicate a previously ascertained data-transmission quality also allows several qualities of data transmission ascertained with the method according to the invention to be evaluated statistically in order to e.g. be able to make more accurate statements about an expected data-transmission quality.

1-23. (canceled)

24. A method for data transmission, comprising:
determining whether at least one data transmission limit value is infringed during a transmitting, over a network, of first data for a first receiver; and
in response to an infringement of the at least one data transmission limit value during the transmitting:
interrupting the transmitting of the first data;
replacing the transmitting of the first data by a transmitting of second data for the receiver; and
discarding the first data.

25. The method as recited in claim 24 further comprising continuing the transmitting of the first data in response to the data transmission limit value not being infringed during the transmitting.

26. The method as recited in claim 24 wherein the at least one data transmission limit value includes a first and a second data transmission limit value, and further comprising:
predefining the first and second data transmission limit values;
predefining a first and a second datum of the second data; and
assigning the first datum to the first data transmission limit value and assigning the second datum to the second data transmission limit value;
wherein the determining whether the at least one data transmission limit value is infringed includes determining which of the first and second data transmission limit values is infringed, and wherein the transmitting of the second data is performed by transmitting the respective first or second datum corresponding to the infringed first or second data transmission limit value.

27. The method as recited in claim 26 wherein the first datum includes a first data packet and the second datum includes a second data packet.

28. The method as recited in claim 24 wherein the infringement of the at least one data transmission limit value includes transmitting, within a predefined period of time, a quantity of data smaller than a predefined quantity of data.

29. The method as recited in claim 28 wherein the first data includes a greater quantity of data than the second data.

30. The method as recited in claim 24 wherein the infringement of the at least one data transmission limit value includes exceeding of a predefined period of time for transmitting a quantity of data of the first data.

31. The method as recited in claim 30 wherein the first data includes a greater quantity of data than the second data.

32. The method as recited in claim 24 wherein the infringement of the at least one data transmission limit value includes transmitting, within a predefined period of time, a quantity of data greater than a predefined quantity of data.

33. The method as recited in claim 32 the first data includes a smaller quantity of data than the second data.

34. The method as recited in claim 24 wherein the infringement of the at least one data transmission limit value includes transmitting of a quantity of data of the first data in a period of time less than a predefined period of time.

35. The method as recited in claim 34 the first data includes a smaller quantity of data than the second data.

36. The method as recited in claim 24 wherein the first data corresponds to a first flash banner and the second data corresponds to a second flash banner.

37. The method as recited in claim 24 further comprising, in response to the infringement of the at least one data transmission limit value, storing data characterizing the at least one data transmission limit value.

38. The method as recited in claim 37 wherein the stored data are stored as cookies.

39. The method as recited in claim 24 wherein the transmitting of the first data is performed by transmitting the first data from a server to a client.

40. The method as recited in claim 39 wherein the interrupting the transmitting of the first data is performed under control of the server.

41. The method as recited in claim 40 wherein the interrupting the transmitting of the first data is performed using a servlet.

42. The method as recited in claim 39 wherein the interrupting the transmitting of the first data is performed under control of the client.

43. The method as recited in claim 42 wherein the interrupting the transmitting of the first data is performed using a web browser.

44. The method as recited in claim 42 wherein the interrupting the transmitting of the first data is performed using a plug-in.

45. The method as recited in claim 43 wherein the interrupting the transmitting of the first data is performed using a plug-in.

46. The method as recited in claim 42 wherein the network includes the Internet.

47. A computer readable medium having stored thereon computer executable process steps operative to perform a method for data transmission, the method comprising:
determining whether at least one data transmission limit value is infringed during a transmitting, over a network, of first data for a first receiver; and
in response to an infringement of the at least one data transmission limit value during the transmitting:
interrupting the transmitting of the first data;
replacing the transmitting of the first data by a transmitting of second data for the receiver; and
discarding the first data.

48. The computer readable medium as recited in claim 47 wherein the method further comprises continuing transmitting of the first data in response to the data transmission limit value not being infringed during the transmitting.

49. The computer readable medium as recited in claim 47 wherein the at least one data transmission limit value includes a first and a second data transmission limit value, and wherein the method further comprises:
predefining the first and second data transmission limit values;
predefining a first and a second datum of the second data; and
assigning the first datum to the first data transmission limit value and assigning the second datum to the second data transmission limit value;
wherein the determining whether the at least one data transmission limit value is infringed includes determining which of the first and second data transmission limit values is infringed, and wherein the transmitting of the second data is performed by transmitting the respective first or second datum corresponding to the infringed first or second data transmission limit value.

50. The computer readable medium as recited in claim 47 wherein the computer executable process steps include at least one of a JavaScript®, a Jscript®, a program compatible with JavaScript®, and a program compatible with Jscript®.
